(19) United States
(12) Patent Application Publication
(10) Pub. No.: US 2014/0199437 A1
(43) Pub. Date: Jul. 17, 2014

(54) Micro-Fermentation of Cocoa

(71) Applicants: Edward Seguine, McLean, VA (US); David Mills, McLean, VA (US); Jean-Philippe Marelli, McLean, VA (US); Juan Carlos Motamayor-Arias, McLean, VA (US); Irene Da Silva Coelho, McLean, VA (US)

(72) Inventors: Edward Seguine, McLean, VA (US); David Mills, McLean, VA (US); Jean-Philippe Marelli, McLean, VA (US); Juan Carlos Motamayor-Arias, McLean, VA (US); Irene Da Silva Coelho, McLean, VA (US)

(73) Assignee: MARS, INCORPORATED, McLean, VA (US)

(21) Appl. No.: 14/238,373

(22) PCT Filed: Aug. 13, 2012
(86) PCT No.: PCT/US2012/050608

§ 371 Date: Feb. 11, 2014

Related U.S. Application Data
(60) Provisional application No. 61/523,148, filed on Aug. 12, 2011.

(51) Int. Cl. A23G 1/02

(52) U.S. Cl. CPC A23G 1/02
USPC 426/45

(57) ABSTRACT

The present invention provides methods for micro-fermentation of cocoa allowing quality evaluation on a tree by tree basis.

### FIELD OF THE INVENTION

### Reference to Related Applications

This application is a national stage application, filed under 35 U.S.C. §371, of International Application No. PCT/US2012/050608, filed Aug. 13, 2012, which claims the benefit of U.S. Ser. No. 61/523,148, filed Aug. 12, 2011, the contents of which is herein incorporated herein by reference in its entirety.

### FIELD OF THE INVENTION

The present invention relates generally to methods of fermenting a small quantity (e.g., 3 pods or less) of cocoa beans.

### BACKGROUND OF THE INVENTION

Cocoa beans are the principal raw material for chocolate production. These beans are derived from the fruit pods of the tree Theobroma cacao, which is cultivated in farms in the equatorial zone, e.g., in Brazil, Costa Rica, Ecuador, Indonesia, Ivory Coast, Ghana and Vietnam. The cocoa beans are surrounded by a mucilaginous pulp inside the pods. Raw cocoa beans have an astringent, unpleasant taste and flavor, and have to be microbially fermented, dried, and roasted to obtain the desired characteristic cocoa flavor and taste.

Chocolate is generally obtained by mixing sugar and cocoa butter with cocoa liquor or cocoa nibs, followed by refining, conching and tempering. Milk chocolate is prepared in a similar way but with the addition of milk or milk powder.

Chocolate flavor is influenced by the origin of the cocoa beans, the cocoa cultivars, the on-the-farm fermentation and drying process, and the roasting and further processing performed by the chocolate manufacturer.

Genotype influences both flavor quality and intensity in chocolate, likely determining the quantities of precursors and the activity of enzymes. Each genotype requires fermentation (also known as curing) appropriate to its type to best express this flavor quality. Large scale techniques for fermentation are widely practiced. See, e.g., Figueira et al., Trop. Agric. (Trinidad) 74, pp. 132-139 (1997). For example, Forastero varieties require a fermentation period of 5 to 8 days for the development of flavor, whereas Criollo cocoa requires 2 to 3 days.

Some suggest that the flavor quality of the fermented seeds is predominantly due to transport kinetics of water and solutes during the fermentation process rather than a reflection of genetically coded differences in storage proteins but the full details of this flavor development are poorly understood. Regardless, significant fermentation effects may relate to factors such as storage protein and accessibility, destruction of cell compartmentalization, enzyme mobilization, and pulp and testa changes. Additionally, the spontaneous cocoa fermentation process is very heterogeneous and suffers from great variations in both microbial counts and species composition and hence metabolites. The variations seem to depend on many factors including country, farm, pod ripeness, post-harvest pod age and storage, pod diseases, type of cocoa, variations in pulp/bean ratio, the fermentation method, size of the batch, season and weather conditions, the turning frequency or no turning, the fermentation time, etc. which makes reproducibility of fermentation particularly difficult. Because the uncontrolled nature of the usual fermentation process, particularly with respect to the lack of control over the growth and development of microorganisms and metabolic production during the process, the quality of the finished cocoa beans is variable.

Many aspects of cocoa research require assessment of quality of the crop produced by a reduced number of experimental trees. Moreover, such examination should be made as early as possible in the productive life of the tree which may yield only one to only a few pods. Thus a need exists for a rapid and effective means of fermenting or curing small quantities of cocoa beans in order to enable tree breeders and cocoa researchers to assess the quality of improved cocoa varieties.

It is noted that prior art methods amalgamate beans from about 6-8 or more pods from more than one tree which are combined and placed within a larger fermentation reaction, (i.e. the 6-8 pods or more are added to the heap). This eliminates the ability to evaluate flavor development on a tree by tree basis. See, e.g., Clapperton et al., Cocoa Growers Bulletin, 48, pp. 4757 (1994). In contrast, the present invention provides a method in which 1-3 pods from a single tree are fermented together in a controlled environment and are not combined into a larger heap. Accordingly, the methods of the invention provide a unique opportunity for tree breeders and cocoa researchers to assess the quality of improved cocoa varieties on a tree by tree or even on a pod by pod basis.

### SUMMARY OF THE INVENTION

The invention provides methods for micro-fermentation of cocoa. In one embodiment, the method of micro-fermentation of cocoa beans, providing cocoa beans from a single tree (preferably derived from three or fewer cocoa pods from the same tree), placing the beans in an airtight container, removing the air from the container and sealing the airtight container. In some embodiments the beans are depulped. Alternatively, in other embodiments the beans are non-depulped. Optionally, prior to removing the air from the container the cocoa beans are inoculated with a cocoa starter culture. The cocoa beans are fermented at controlled temperature under anaerobic conditions for a first predetermined period of time (from 12-72 hours). The cocoa sweatings are separated from the cocoa beans at one or more second predetermined periods of times. In one embodiment The cocoa sweating are removed after fermentation is complete. Alternatively, the cocoa sweating are removed at one or more predetermined periods of time during fermentation. Optionally, the method includes fermenting the cocoa beans at a controlled temperature under partially aerobic conditions for a third predetermined period of time (from 12-144 hours). The fermented cocoa beans are dried until the total moisture content of the cocoa beans is about 5-10 percent; and then optionally the cocoa beans are aged for a forth predetermined period of time (e.g., 2-10 weeks). In some embodiments the bean are placed in a net bag that is then placed into the airtight container. This provides an easy and convenient way to lift the group of beans out of the airtight container when separating the cocoa beans from the cocoa sweatings. In some embodiments, the net bag is a plastic net bag, preferably a polyethylene net bag or a polypropylene bag. In some embodiments, the next bag is jute. In some embodiments, the airtight container is a plastic container, preferably polyethylene or polypropylene, preferably a zip lock bag, because it is easy to remove the air from it—press it out and seal. The skilled artisan will recognize that any plastic type may be used, including without limitation PE, HDPE, LDPE, PP, PET, PEN or Nylon.

The ordinarily skilled artisan will realize that oxygen may permeate via the side walls of a polyethylene bag, even if at a slow rate. Accordingly, the term airtight means “substantially” or “effectively” airtight during the fermentation process. Further, the skilled artisan will also realize that unless performed under a vacuum, all the air cannot be completely removed from the airtight container. Accordingly, when air is removed from the airtight container and sealed, some air will remain in the container.

In a further embodiment, the method further comprises roasting the cocoa beans; removing the shell and milling the recovered cocoa nibs into chocolate liquor.

Other features and advantages of the invention will be apparent from and encompassed by the following detailed description and claims.

### BRIEF DESCRIPTION OF THE DRAWINGS

FIG. 1 shows a flowchart of the micro-fermentation method according to the invention.

FIG. 2 shows a temperature profile during micro-fermentation.

FIG. 3 is a series of Star-Plots for each of the 10 clones examined showing that the chocolate liquor produced by the micro-fermentation process of the invention have discernable fermented cocoa favor attributes.

### DETAILED DESCRIPTION OF THE INVENTION

This invention provides a method of fermenting small quantities of cocoa (e.g., bean from three pods or less, preferably two pods or less, and most preferably one pod or less) in a reproducible and controlled fashion in order to perform breeding or other studies (such as soil nutrition) on flavor on an individual tree basis, which is not possible using traditional fermentation techniques. The method allows for the assessment of the cocoa attributes of a single cocoa tree at a particular time. This allows for the attributes of a particular cultivar to be assessed much earlier than previously possible. (e.g., when the tree only has produced one to three pods) Specifically, this allows the attributes of a single cultivar to be determined during the first production year and prior to cloning and cultivation. The novel method has use in screening cocoa trees on an individual basis for flavor development. The method is useful for example in breeding trials in order to produce a more consistent high quality product. Further uses of the methods of the invention are to evaluate and screen the effect of the addition of different substrates or treatments on the fermentation process, on the taste and quality of the cocoa liquor and corresponding chocolate. This technique can be used to evaluate analytical chemical parameters as well. For instance, you can use this technique to evaluate cocoa flavanol (CF) content on fermented and dried beans comparing one cultivar (clone) against another in terms of CF retention during the fermentation process. This technique may be used in conjunction with GC-MS or HPLC-MS analysis or other suitable analytical techniques for evaluating a constituent of interest.

Unless otherwise defined, all technical and scientific terms used herein have the same meaning as commonly understood by one of ordinary skill in the art to which this invention pertains. Although methods and materials similar or equivalent to those described herein can be used in the practice of the present invention, suitable methods and materials are described below. All publications, patent applications, patents, and other references mentioned herein are expressly incorporated by reference in their entirety. In cases of conflict, the present specification, including definitions, will control. In addition, the materials, methods, and examples described herein are illustrative only and are not intended to be limiting.

In the present invention, the tree material is preferably derived from any species of the genera Theobroma or Herrania or inter- and intra-species crosses thereof within those genera, and more preferably from the species Theobroma cacao and Theobroma grandiflorum. The species Theobroma cacao as used herein comprises all varieties, particularly all commercially useful varieties, including but not limited to Criollo, Forastero, Trinitario, Arriba, Amelonado, Contamana, Curaray, Guiana, Iquitos, Maranon, Nacional, Nanay and Purus, and crosses and hybrids thereof. Cocoa beans derived from the fruit pods of Theobroma cacao are the principal raw material for chocolate production. The cocoa beans are surrounded by a mucilaginous pulp inside the pods. After the pods are harvested, the cocoa beans (usually including at least a portion of the surrounding pulp) are recovered from the pods. Accordingly, the tree material used in the method of the invention may preferably comprise cocoa beans derived from the fruit pods of Theobroma cacao, and may further comprise the pulp derived from the said fruit pods. In an embodiment, the tree material may consist essentially of cocoa beans and the pulp derived from the fruit pods of Theobroma cacao.

The terms “cocoa” and “cacao” as used herein are considered as synonyms.

The term “fermentation” refers generally to any activity or process involving enzymatic or metabolic decomposition (digestion) of organic materials by microorganisms. The fermentation process may also involve production of useful compounds and substances, typically organic compounds and substances, by the microorganisms. The compounds may advantageously influence or determine one or more characteristics of the fermented material and/or materials or products prepared by further processing involving the fermented material. By means of example and not limitation, such characteristics may involve various sensorial, organoleptic, nutritional, technological, compositional, or qualitative properties of the fermented material and/or further products there from, e.g., contents of particular compounds, taste, flavor, aroma, texture, colour, rheology, etc. The term “fermentation” encompasses both anaerobic and aerobic processes, as well as processes involving a combination or succession of one or more anaerobic and/or aerobic stages. “Anerobic” fermentation is meant that the conditions are such the decomposition of organic matter by microorganisms that prefer anaerobic conditions (e.g. yeast) are favored over the decomposition of organic matter by microorganisms that prefer aerobic conditions (e.g., bacteria). Likewise, “aerobic” fermentation is meant that the conditions are such the decomposition of organic matter by microorganisms that prefer aerobic conditions (e.g. bacteria) are favored over the decomposition of organic matter by microorganisms that prefer anaerobic conditions (e.g., yeast). One skilled in the art will appreciate that total (i.e absolute) anaerobic or aerobic conditions need not be achieved for fermentation to occur.

The term “cocoa beans” as used herein is intended to refer to cocoa beans or cocoa seeds as such as well as parts thereof and includes cocoa nibs. Cocoa beans basically consist of three parts: an outer part comprising the testa or seed coat surrounding the bean; an inner part comprising the cotyledons and the embryo or germ contained within the testa; and the pulp. In the present specification, the terms “testa” or “shell” or “seed coat” are used as synonyms. The term “pulp” in accordance with the present invention relates to the mucilaginous tree material in which cocoa beans are embedded inside the cocoa pods.

The term “fermented cocoa beans” is intended to refer to cocoa beans that have been fermented for at least one day, preferably at least two days, thus, that have undergone a fermentation process. The ordinarily skilled artisan will appreciate that the fermentation time depends on the cocoa bean type.

As used herein the term “non-depulped” cocoa beans refers to cocoa beans that have not been liberated from their pulp. The term “depulped” cocoa beans refers to cocoa beans that have been essentially liberated from their pulp. Preferably “essentially liberated” refers to the removal from the cocoa beans of more than 40%, preferably more than 65, 70, 75, 80, 85, 90, 95, 97, or 99% by weight of pulp based upon the original total combined weight of beans and pulp. The micro-fermentation process according to the invention can use non-depulped cocoa beans, depulped cocoa beans or partially de-pulped cocoa beans.

The term “regulating” or “controlling” as used herein in relation to the fermentation of organic material encompasses but is not limited to initiating a fermentation process and/or initiating a particular stage of the fermentation process; accelerating or decelerating a fermentation process and/or accelerating or decelerating a particular stage of the fermentation process; initiating and/or accelerating or decelerating the transition from one stage of a fermentation process to another stage of the fermentation process (e.g., the transition from mainly yeast-mediated fermentation to mainly lactic acid bacteria (LAB)-mediated fermentation, or from the mainly LAB-mediated fermentation to mainly acetic acid bacteria (AAB)-mediated fermentation during the fermentation process of cocoa beans and pulp); altering the conditions of the fermentation, such as, e.g., temperature or pH; altering the composition of the fermented material (e.g., altering the decomposition or production of particular substances present in the fermented material); altering the identity and/or quantity of microbial strains present in and/or carrying out the fermentation process; enhancing or suppressing the growth of particular microorganisms etc.

A “spontaneous” fermentation or “natural fermentation” or fermentation process as used herein is one that employs endogenous microorganisms naturally present in and/or unconsciously introduced into the fermented organic material at the start or during the fermentation. By means of example and not limitation, in spontaneous fermentation of cocoa beans and pulp, microorganisms may be introduced after the beans and the pulp are released from the pods from natural microbiota present, for example, on workers' hands, tools (knifes, shovels, unwashed baskets, etc.), fermentation, box or basket coverings such as banana leaves, jute or other sacks and in places of previous fermentations. Accordingly, in the methods of the invention an otherwise spontaneous fermentation may be regulated by addition of a composition comprising one or more LAB and/or AAB strains, one more yeast strains, or any combination thereof to organic material e.g., cocoa beans and pulp. Hereby, the microbial presence in the materials is altered and the fermentation is thereby regulated (manipulated or modulated). The microbial strains introduced by means of the said compositions may be the same or similar (e.g., of the same species and/or genus) to those naturally found in the organic material and/or may be different (e.g., of a different species and/or genus).

“Traditional” or “Conventional” fermentation is meant the fermentation process that occurs during the commercial production of cocoa, i.e., the large scale fermentation in a heap, box or basket. Traditional or convention fermentation in the context of the present invention is also meant to include the fermentation of cocoa beans from pods from more than one cocoa tree. Traditional and convention fermentation also includes fermentation of cocoa beans from pods from one or more trees by adding the beans to a pre-existing fermentation heap, box or basket.

The present method encompasses the processing of cocoa beans by harvesting cocoa beans from three or less cocoa pods from a single tree, preferably a two or less cocoa pods from a single tree; or more preferably one or less cocoa pods from a single tree, and transferring the beans to an airtight container. An individual pod typically have about 40 beans and weighs about 75-200 grams (beans plus pulp) A skilled artisan can appreciate that the size of pods can vary greatly and according the number of uses in the methods of the invention would vary in order to provide the desired amount (by weight) of beans. For example, about 25 grams, 50 grams, 100 grams, 150 grams, 200 grams, 250 grams, 300 grams, 350 grams, 400 grams, 450 grams, 500 grams, 550 grams, 600, grams of organic matter (i.e. bean with or without pulp) are placed into the airtight container for the micro-fermentation process of the invention. For ease of handling, preferably the beans are placed into a net bag prior to transfer into the airtight container. Preferably the airtight container is essentially sterile. In one embodiment the airtight container is a polypropylene container. In another embodiment the airtight container is a polyethylene zip lock bag.

Optionally, the cocoa beans are inoculated with a cocoa starter culture. The term “starter culture” refers to a composition comprising live microorganisms that are capable of initiating or effecting fermentation of organic material, optionally after being cultivated in a separate starter medium for obtaining a high density culture. A starter culture may be, e.g., a liquid culture, liquid pressed culture, frozen or dried form, including, e.g., freeze dried form and spray/fluid bed dried form, or frozen or freeze-dried concentrated. A starter culture may also be material that is obtained by scrapping material from an existing fermentation box or the sweating from an existing fermentation reaction. When a liquid culture is used preferably at least 1, 2, 3, 4, 5, 6, 7, 8, 9, 10, 15, 20, 25, 30, 35, 40, 45, 50 mL of culture is used. The culture may be packed in vacuum, or under an atmosphere of, e.g., N2, CO₂ and the like. For example, a starter culture may be produced and distributed in sealed enclosures, which can be made of a rigid, non-flexible or flexible suitable plastic or other material, to the fermentation place and may be either added to organic material to be fermented, or optionally first cultivated in a separate starter medium to obtain a high density culture. Any suitable starter culture known in the art may be used (see, e.g., WO 2007/031186). A preferred starter culture is the one described in Example 1.

A starter culture may also contain, in addition to the microorganisms, buffering agents and growth stimulating nutrients (e.g., a digestible carbohydrate or a nitrogen source), enzymes (e.g. pectinase) or preservatives (e.g., cryoprotective compounds) or other carriers, if desired, such as milk powder or sugars.

A starter culture may be a natural culture, i.e. contains wild microflora. Alternatively, the starter culture may be a pure culture, i.e., may contain a biomass of one single isolate (i.e. a clone originating in principle from one cell) of lactic acid bacteria (LAB), acetic acid bacteria (AAB) or yeast. In other embodiments, a starter culture may be a co-culture, i.e., may comprise more than one strain of LAB, AAB or yeast.

When the methods of the invention are being used to compare cocoa from different cultivars, a skilled artisan will appreciate that it may be desirable to use the same starter culture for the each of the micro-fermentation reactions

The optional starter culture may be incubated for about 1-48 hrs prior to adding to the beans. Preferably, the starter culture is incubated for about 1-30 hrs prior to adding to the beans. More preferably, the starter culture is incubated for about 3-16 hrs prior to adding to the beans.

Once the beans and optional starter culture are placed in the container, the air is removed from the airtight container and the container is sealed. This removal of the air is an important step in initiating the first phase of anaerobic fermentation. The cocoa beans are fermented under anaerobic conditions for a first predetermined period of time, such first predetermined period of anaerobic fermentation being about 12, 24, 36, 48, 60, 72 hours or more, preferably about 48 hours.

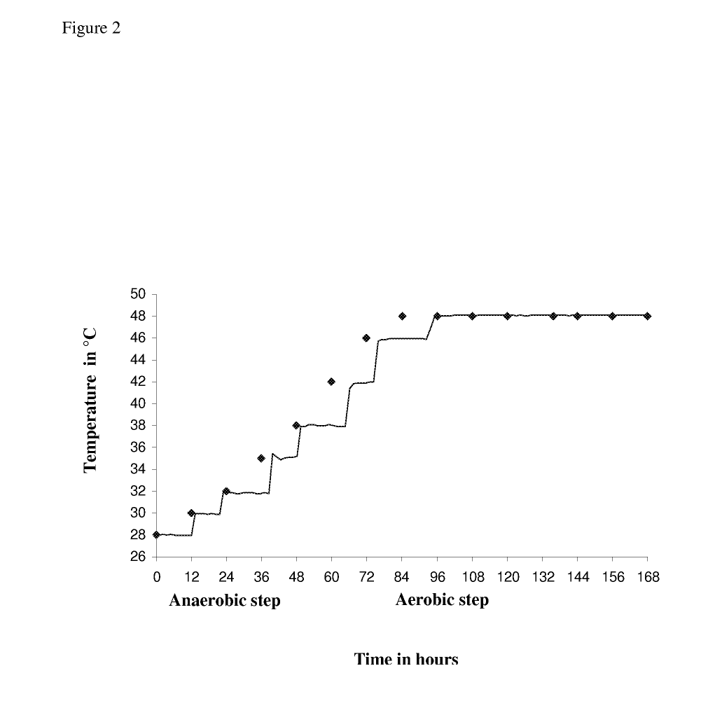

The fermentation process is carried out at a controlled temperature, preferably in a microbiological incubator. “Controlled temperature” means that the temperature is regulated such that the temperature mimics what happens in a traditional fermentation heap, box or basket. For example, during the anaerobic fermentation phase the temperature increases from 25-30° C. to about 34-40° C. FIG. 2 shows an example of typical temperature control during fermentation. Preferably, the temperature profile maintained during the microfermentation process should be similar to the temperature profile as a conventional large scale fermentation process.

The cocoa beans are then optionally further fermented at a controlled temperature under aerobic conditions for a second predetermined period of time. For example, the cocoa beans are optionally aerobically fermented for about 12, 24, 36, 48, 60, 72, 84, 96, 108, 120, 132, 144 hours or more, preferably about 120 hours. During the aerobic fermentation phase the temperature is increased from about 40° C. to about 50° C. or higher using an incubator. FIG. 2 shows an example of typical temperature profile during aerobic fermentation.

During fermentation, the process produces wet “sweatings”. During the period of fermentation, the airtight container is optionally opened one or more times to drain the sweatings. Alternatively, the sweating are not drained until fermentation (e.g. anaerobic and the option aerobic fermentation) is completed. One skilled in the art would recognize that if it was desired to stop fermentation prior to the completion of fermentation that draining of the sweating and drying the beans is one method in which this could be achieved.

In various embodiments the sweatings are drained at 24, 36, 48, 60, 72, 96 or 120 hours after the start of the micro-fermentation process. In some embodiments, the sweating are drained at 48 hours and 96 hours after the start of the micro-fermentation process. In other embodiments, the sweating are drained at 72 hours and 120 hours after the start of the micro-fermentation process. In preferred embodiments the sweating are not first drained until 72 hours after the start of the micro-fermentation process.

When it is desired that the sweating are drained during anerobic fermentation, after the desired period, the sweatings are separated from the cocoa beans, air is let into the container, the beans are replaced into the same or different airtight container and the container is sealed. If desired, air is pressed out of the container prior to sealing. Although, during this process air (e.g. oxygen) is allowed into the container (e.g. bag), one skilled in the art will appreciate that the growth and the metabolism of the anaerobic microorganisms (e.g. yeast) is vigorous enough to resume anaerobic fermentation to continue. One skilled in the art will appreciate that if the sweatings are removed during aerobic fermentation, the addition of air (e.g. oxygen) upon opening of the sealed container will have little to no consequence on the aerobic fermentation.

After anaerobic fermentation and the optional aerobic fermentation the cocoa beans are dried until the total moisture content is less that 10 percent, preferably the cocoa beans are dried to about 7 to 8 percent moisture. Once dried to the appropriate moisture content, the cocoa beans may be aged for a third predetermined period of time. For example, the cocoa beans are aged for 2, 3, 4, 5, 6, 7, 8, 9, 10 or more weeks, preferably at least 6 weeks, at room temperature, prior to liquor making. When the cocoa is first dried, it has been have discovered by the present inventors that there are significant flavor notes present or they display differently, that are not present when beans are well aged. The aging is an exponential decay function in which we have found that generally 6 weeks appears to be a good point to age to get most of the change to occur. Some varieties may age faster, some may age a bit slower, but in general the 6 week aging is a good balance point between undue aging time and eliminating some flavor artifacts.

After the cocoa beans are dried and optionally aged, the beans are roasted and milled to liquor using procedures well known in the art, including roasting the beans; removing the shell and milling the recovered cocoa nibs into chocolate liquor. The chocolate liquor obtained has flavor profile characteristics of chocolate liquor produced by traditionally fermented cocoa beans. By flavor profile characteristics of chocolate liquor produced by traditionally fermented cocoa beans is meant that an individual trained in chocolate sensorial analysis and familiar with the flavor of clones fermented via traditional fermentation processes will recognize that the flavor obtained by the micro fermentation method of the invention produces flavors typical of what experts would expect over a large number of commercial or conventional scale fermentations of these clones.

In some embodiments, the chocolate liquor obtained is substantially similar to the flavor profile of chocolate liquor produced by traditionally fermented cocoa beans. By substantially similar is meant that an individual trained in chocolate sensorial analysis cannot detect a flavor profile difference between the chocolate liquor obtained by the microfermentation method of the invention and the chocolate liquor obtained by traditional fermentation.

Each sample can be evaluated for, including but not limited to, the following flavor attributes: “cocoa flavour” (as found in Ghanaian beans), “acidity” (qualifies the basic taste generated by dilute aqueous solutions of most acids), “bitterness” (qualifies the basic taste generated by dilute solutions of various substances such as caffeine, perceived on the top of the tongue and at the back of the palate), “fruity” (taste note belonging to the bouquet and which evokes a fruit which has reached maturity: apple, banana, pear and the like), “flowery”, e.g. “total floral’ or “floral woody” (corresponds to an olfactory sensation evoking flowers in general: rose, jasmin, hyacinth, lilac and the like), “nutty, nut skins, and caramel notes” (the taste and odor of roasted nuts, nut skins, and caramelized sugars) “smoky” (taste and odor of smoke; defect resulting in general from drying the cocoa beans after fermentation by means of a wood fire), “hammy” (taste and odor of smoked ham or other smoked meat; defect resulting in general from diseased cocoa beans, “musty” (taste and odor of damp slightly moldy materials), and “raw” (feature of insufficiently roasted cocoas where the flavor has not developed); “earthy” (corresponds to an olfactory sensation that evokes fresh clean slightly damp earth or potting soil or the rich smell of the earth in a forest after a light rain). “bark woody”, “dirty”, etc. In addition, each sample can be evaluated for other sensations, including but not limited to, “astringency” (corresponds to sensations of a physical nature, from the suppression of unctuousness to the astringency in the medical sense which covers constriction and/or crispation of the tissues) or “other” (a compilation of flavors otherwise specified in the aforelisted attributes).

By regulating the above and other aspects of fermentation, the present invention allows for controlling or manipulating, by means of example and not limitation, the rate of fermentation, the extent of fermentation, rapidity and productivity of the fermentation, the quality and/or quantity of both desirable and undesirable substances present in the fermented material, and characteristics of the fermented material and/or products obtained by further processing of the fermented material, such as chocolate liquor, cocoa powder, cocoa butter or chocolate.

### EXAMPLES

### Example 1

### Micro-Fermentation of Cocoa

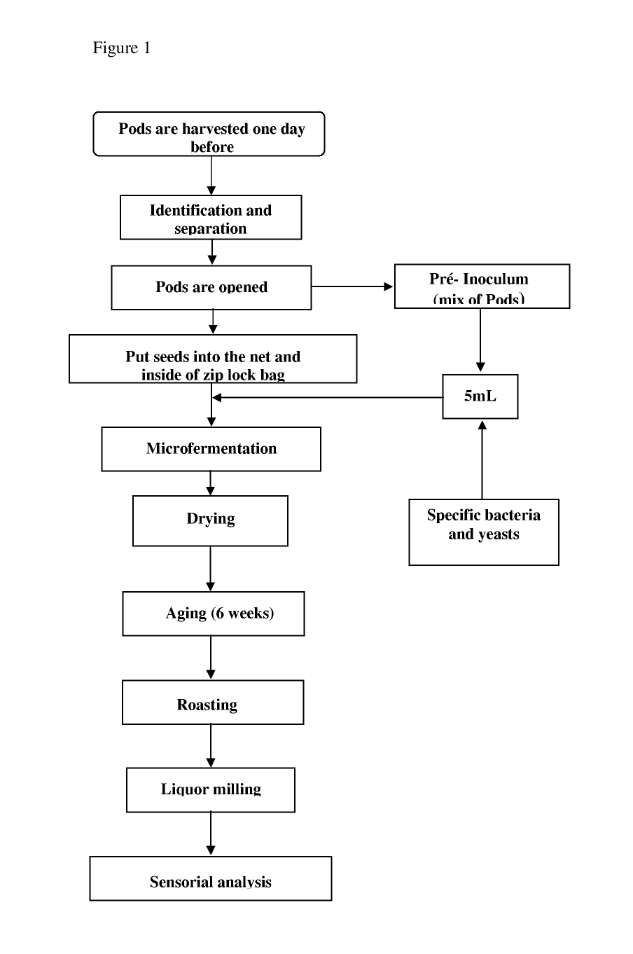

The pods were collected from individual trees when they reached maturity and taken to the fermentation site located outside the laboratory one day before. Each pod was cut by half with a knife (superficially disinfested with 70% ethanol). The beans (without the placenta) from inside one pod from one tree were taken out by the worker wearing latex gloves and immediately transferred to an polyethylene net bag and subsequently placed inside an airtight polypropylene zip lock bag (23×18 cm) (Wyda Practic, Sao Paulo, BR) and sealed. The procedure takes about one minute per pod. To form a starter culture, 10 pods from each of open-pollinated CCN51 and TSH1188 clones were opened to collect the cocoa beans and taken to the lab. In the laboratory the pods were depulped using a modified blender in which the blade was removed and replaced with an agitator in the following proportion: 50 g of fresh seed+100 mL water for 1 minute. This quantity varies depending on the amount of pods to be fermented. The pulp was filtered through a kitchen sieve and the supernatant was transferred to an Erlenmeyer flask capped with aluminum foil and left at room temperature (outside the laboratory) for 3 hours to form a starter culture inoculum. Any suitable starter culture may be used. Each individual zip-lock bag was then taken to the laboratory, opened and 5 mL of previously prepared inoculum added to each bag (the inoculum amount depends on the concentration of microorganism in the medium). The air was removed from the zip lock bags, by placing them on a flat surface and pressing all the air out, and then the bags were sealed. The zip lock bags were placed in an incubator with controlled temperature (according to FIG. 1). The temperature was adjusted throughout the process using a probe placed inside the incubator, so as to drive the temperature of all of these bags to follow a “typical” fermentation temperature curve as if the bag were just a part of a commercial heap/box/or basket. This is necessary because, due to the small volume of beans used, if temperature was not adjusted to track a traditional fermentation, the temperature of the beans in the bags would not rise much. The reason for this is that the quantity being fermented is very small, and the heat loss to the environment is much greater than the heat generated by traditional fermentation. Fermentation, therefore, would be inadequate.

The cocoa was fermented for about 7 days. The sweatings (liquid pulp that drains out of the beans) were collected at time 48 and 96 hours by opening the bag, removing the net containing the beans and draining the sweatings out of the plastic bag (to simulate the drainage of the sweatings in the fermentation heap) and re-closing the bag. After fermentation, the beans were dried (in one method the beans are placed on a flat surface to sun dry the beans) until the moisture reached 7-8% (commercially dried beans are typically dried to about 5-10% moisture). This step takes approximately 4 to 10 days depending on the weather conditions. Then each set of beans from the same pod was stored in individual jute bags for 6 weeks at room temperature in a cocoa warehouse prior the liquor making. After storage, beans were roasted and milled to liquor, under standard laboratory conditions.

### Example: 2

### Flavor Analysis of Micro-Fermented Cocoa Beans

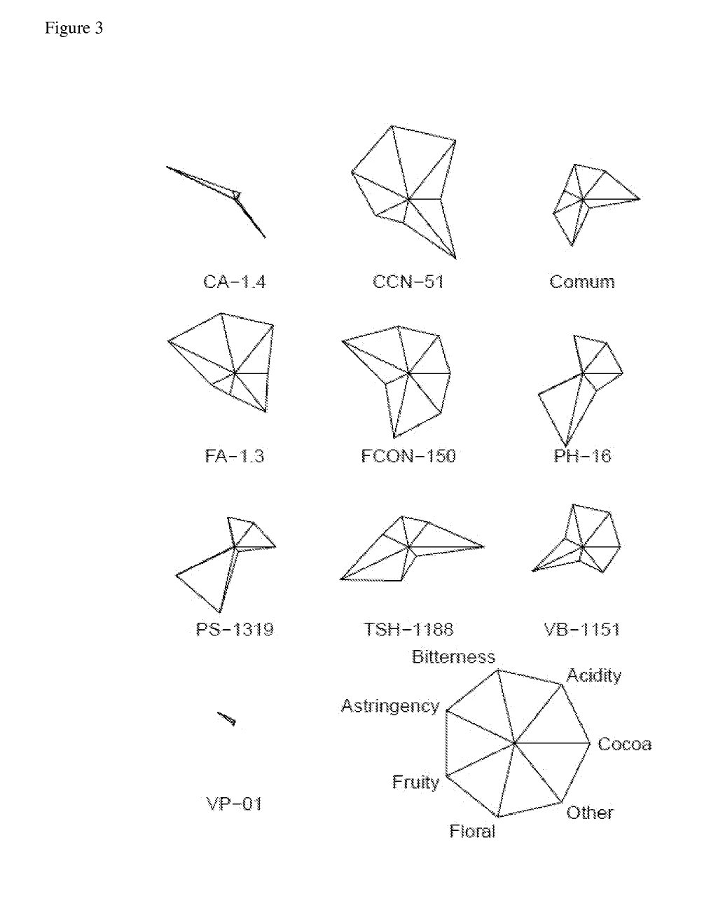

Beans obtained from a single tree from ten individual clones were micro-fermented according to the method of the invention. The clones accessed were CA-1.4, CCN-51, Comum, FA-1.3, FCON-150, PH-16, PS-1319, TSH-1188, VB-1151 and VP-01. Flavor analysis was performed by a professional flavor taster on samples of the liquor. Specifically, floral, fruity, astringency, bitterness, acidity, cocoa, and other flavor attributes of the micro-fermented cocoa beans were assessed. As shown in the Star-Plots in FIG. 3, the chocolate liquor produced by the micro-fermentation process of the invention have discernable fermented cocoa favor attributes. More importantly, as expected each clone had a unique flavor profile.

Moreover, the experiments demonstrated the reproducibility of the micro-fermentation process (i.e., consistency of the cocoa flavor attributes between replicate micro-fermentation processes). (data not shown)

### Example 3

### Effect of Bean and Inoculum Quantities in Micro-Fermentation on Flavor

The effect of sample size (i.e amount of beans) and amount of inoculum on the flavor of the chocolate liquor produced from microfermented cocoas was determined. For each of the 10 clones described about five different sample sizes (50 grams, 100 grams, 200, grams, 400 grams, or 600 grams) and seven different inoculums sizes (0 ml, 1 ml, 3 ml, 5 ml, 10 ml, 20 ml or 40 ml). The Table below summarizes the flavor profile of the chocolate liquor produced by the micro-fermentation process of the invention. The ratings listed for each attributes was an average of 9 tasting, (3 tasting of 3 different liquor batches tasted by a professional taster in a double blind taste test.

| | Sample | Inoc | Cocoa | Acidity | Bitterness | Astringency | Fruity | Floral | Other |
|---|---|---|---|---|---|---|---|---|---|
| 1 | 50 | 0 | 6.67 | 0.78 | 4.53 | 5.24 | 1.49 | 2.27 | 0.68 |
| 2 | 100 | 0 | 6.58 | 0.90 | 4.58 | 5.35 | 1.47 | 2.18 | 0.79 |
| 3 | 200 | 0 | 6.38 | 1.15 | 4.68 | 5.58 | 1.41 | 1.99 | 1.02 |
| 4 | 400 | 0 | 5.99 | 1.64 | 4.89 | 6.03 | 1.29 | 1.61 | 1.46 |
| 5 | 600 | 0 | 5.59 | 2.13 | 5.09 | 6.49 | 1.18 | 1.22 | 1.91 |
| 6 | 50 | 1 | 6.66 | 0.79 | 4.52 | 5.23 | 1.50 | 2.27 | 0.69 |
| 7 | 100 | 1 | 6.56 | 0.92 | 4.58 | 5.35 | 1.47 | 2.18 | 0.80 |
| 8 | 200 | 1 | 6.36 | 1.17 | 4.69 | 5.59 | 1.41 | 1.98 | 1.03 |
| 9 | 400 | 1 | 5.97 | 1.67 | 4.90 | 6.06 | 1.30 | 1.60 | 1.48 |
| 10 | 600 | 1 | 5.58 | 2.15 | 5.12 | 6.53 | 1.18 | 1.22 | 1.93 |
| 11 | 50 | 3 | 6.63 | 0.81 | 4.51 | 5.23 | 1.52 | 2.27 | 0.71 |
| 12 | 100 | 3 | 6.53 | 0.94 | 4.37 | 5.36 | 1.49 | 2.17 | 0.82 |
| 13 | 200 | 3 | 6.34 | 1.20 | 4.69 | 5.61 | 1.43 | 1.98 | 1.05 |
| 14 | 400 | 3 | 5.95 | 1.72 | 4.93 | 6.11 | 1.30 | 1.59 | 1.52 |
| 15 | 600 | 3 | 5.56 | 2.24 | 5.17 | 6.61 | 1.18 | 1.20 | 1.98 |
| 16 | 50 | 5 | 6.60 | 0.83 | 4.51 | 5.23 | 1.53 | 2.26 | 0.72 |
| 17 | 100 | 5 | 6.50 | 0.96 | 4.57 | 5.36 | 1.50 | 2.16 | 0.84 |
| 18 | 200 | 5 | 6.31 | 1.24 | 4.70 | 5.62 | 1.44 | 1.97 | 1.08 |
| 19 | 400 | 5 | 5.92 | 1.78 | 4.96 | 6.15 | 1.31 | 1.58 | 1.55 |
| 20 | 600 | 5 | 5.53 | 2.32 | 5.22 | 6.68 | 1.19 | 1.19 | 2.03 |
| 21 | 50 | 10 | 6.52 | 0.87 | 4.48 | 5.22 | 1.57 | 2.25 | 0.77 |
| 22 | 100 | 10 | 6.42 | 1.02 | 4.56 | 5.37 | 1.54 | 2.15 | 0.89 |
| 23 | 200 | 10 | 6.23 | 1.32 | 4.72 | 5.67 | 1.47 | 1.95 | 1.14 |
| 24 | 400 | 10 | 5.85 | 1.92 | 5.03 | 6.27 | 1.33 | 1.56 | 1.65 |
| 25 | 600 | 10 | 5.47 | 2.52 | 5.25 | 6.88 | 1.19 | 1.16 | 2.15 |
| 26 | 50 | 20 | 6.36 | 0.97 | 4.44 | 5.20 | 1.65 | 2.22 | 0.85 |
| 27 | 100 | 20 | 6.27 | 1.14 | 4.54 | 5.39 | 1.61 | 2.12 | 0.99 |
| 28 | 200 | 20 | 6.09 | 1.50 | 4.76 | 5.77 | 1.53 | 1.92 | 1.27 |
| 29 | 400 | 20 | 5.72 | 2.21 | 5.18 | 6.52 | 1.37 | 1.51 | 1.83 |
| 30 | 600 | 20 | 5.35 | 2.92 | 5.60 | 7.27 | 1.21 | 1.11 | 2.39 |
| 31 | 50 | 40 | 6.05 | 1.15 | 4.35 | 5.17 | 1.80 | 2.16 | 1.03 |
| 32 | 100 | 40 | 5.97 | 1.39 | 4.51 | 5.43 | 1.75 | 2.06 | 1.20 |
| 33 | 200 | 40 | 5.80 | 1.85 | 4.83 | 5.95 | 1.65 | 1.84 | 1.53 |
| 34 | 400 | 40 | 5.45 | 2.78 | 5.47 | 7.00 | 1.44 | 1.42 | 2.20 |
| 35 | 600 | 40 | 5.11 | 3.72 | 6.11 | 8.04 | 1.24 | 0.99 | 2.87 |

We claim:

1. A method of micro-fermentation of cocoa beans comprising:
a. providing cocoa beans from three or less pods from a single tree, wherein the beans are placed in an airtight container;
b. removing the air from the container and sealing the airtight container;
c. fermenting the cocoa beans at a controlled temperature under anaerobic conditions for a first predetermined period of time;
d. separating the cocoa sweatings from the cocoa beans at one or more a second predetermined times; and
e. drying the cocoa beans until the total moisture content is about 5-10 percent.

2. The method of claim 1, wherein the method further comprises inoculating the cocoa beans with a cocoa starter culture prior to step (b).

3. The method of claim 1, wherein the method further comprises fermenting the cocoa beans at a controlled temperature under partially aerobic conditions for a third predetermined period of time prior to step (d) or (e).

4. The method of claim 1, wherein the cocoa beans are aged for a forth predetermined period of time after step (e).

5. The method of claim 1, wherein the favor profile of the chocolate liquor obtained from the micro-fermented cocoa beans is substantially similar to the flavor profile of chocolate liquor produced from traditionally fermented cocoa beans.

6. The method of claim 1, wherein the method further comprise roasting the cocoa beans produced by step (e) or claim 4 and removing the shell and milling the recovered cocoa nibs into chocolate liquor.

7. The method of claim 1, wherein the cocoa beans are placed in a net bag before being placed in the airtight container.

8. The method of claim 1, wherein the airtight container is plastic.

9. The method of claim 1, wherein the airtight container is a polypropylene zip lock bag.

10. The method of claim 1, wherein the starter culture is prepared using specific yeasts and/or bacteria.

11. The method of claim 1 wherein the cocoa beans are derived from two or fewer cocoa pods.

12. The method of claim 1, wherein the cocoa beans are derived from one or fewer cocoa pods.

13. The method of claim 1, wherein the first predetermined period of time is from 12-72 hours

14. The method of claim 1, wherein the third predetermined period of time is from 12-144 hours.

15. The method of claim 1, wherein the forth predetermined period of time is from 2-10 weeks.

16. The method of claim 1, wherein the sweatings are removed at one or more predetermined period of times during anaerobic fermentation.

17. The method of claim 3, wherein the sweatings are removed at one or more predetermined period of times during aerobic fermentation.

18. The method of claim 1, wherein the sweating are removed after the completion of fermentation.
